(19) United States
(12) Patent Application Publication
(10) Pub. No.: US 2025/0139394 A1
(43) Pub. Date: May 1, 2025

(54) Balancing Decoding Performance and Speed Using One or More Parameters for Decoding Damaged Data Matrix Barcodes

(71) Applicant: ZEBRA TECHNOLOGIES CORPORATION, Lincolnshire, IL (US)

(72) Inventor: Peizheng Ma, East Setauket, NY (US)

(21) Appl. No.: 18/385,875

(22) Filed: Oct. 31, 2023

(51) Int. Cl. G06K 7/14

(52) U.S. Cl. CPC G06K 7/1447; G06K 7/1417; G06K 7/1452

(57) ABSTRACT

Imaging devices, systems, and methods for capturing image data for an object appearing in a field of view (FOV) are described herein. An example device includes: an imaging assembly; a decode module; and a computer-readable media storing machine readable instructions that cause the imaging device to: (i) detect an indication of a parameter change for a decode parameter associated with the imaging device, wherein the decode parameter is indicative of damage associated with the indicia; (ii) transition, responsive to detecting the indication of the parameter change, from a first operation mode to a second operation mode, wherein the decode module is configured to decode the indicia based at least on the damage associated with the indicia while operating in the second operation mode; (iii) receive, from the imaging assembly, image data of an indicia appearing in the FOV; and (iv) decode, at the decode module, the indicia.

### BACKGROUND

Barcode reading systems have long been used to capture barcode data, which is then used to look up information regarding the item in question. However, barcodes and/or other indicia may be damaged (e.g., by standard wear, weather, malicious actors, printing issues, etc.), and traditional systems may not be able to successfully decode damaged barcodes and/or decode such damaged barcodes in an efficient manner. As such, a traditional system may attempt to decode the damaged barcode only to fail or experience a timeout event to occur. Some traditional systems attempt to mitigate the risk of damaged barcodes by allowing users to manually input information associated with the barcode, but such mitigations introduce a risk of human error. Alternatively, some traditional systems instead decode every element of a barcode individually to gather as much information as possible from the barcode to attempt to perform a decode operation, particularly for 1-dimensional (1D) barcodes. However, these techniques slow down the operation of a barcode reading system, as the system indiscriminately subjects each indicia being scanned to such scrutiny. As such, a system that is able change operation modes to decode a damaged barcode when reading a damaged barcode is desired.

### SUMMARY

In an embodiment, an imaging device is provided. The imaging device includes: an imaging assembly configured to capture image data of an indicia appearing in a field of view (FOV) and a decode module configured to decode the indicia using the image data. The system further includes a computer-readable media storing machine readable instructions that, when executed, cause the imaging device to: (i) detect an indication of a parameter change for a decode parameter associated with the imaging device, wherein the decode parameter is indicative of damage associated with the indicia; (ii) transition, responsive to detecting the indication of the parameter change, from a first operation mode associated with decoding the indicia to a second operation mode associated with decoding the indicia, wherein the decode module is configured to decode the indicia based at least on the damage associated with the indicia while operating in the second operation mode; (iii) receive, from the imaging assembly, image data of a damaged indicia appearing in the FOV, wherein the damaged indicia is representative of the indicia and the damage associated with the indicia; and (iv) decode, at the decode module, the damaged indicia in accordance with the second operation mode.

In a variation of this embodiment, the indicia is a two-dimensional (2D) barcode including a finder pattern and/or a timing pattern positioned along at least one edge of the 2D barcode.

In another variation of the embodiment, the computer-readable media further stores additional instructions that, when executed, cause the imaging system to: after decoding the damaged indicia, transition from the second operation mode to the first operation mode.

In another variation of the embodiment, the decode module is configured to decode the indicia without the damage associated with the indicia while operating in the first operation mode.

In another variation of the embodiment, the imaging device in the first operation mode has a first timeout period for decoding the indicia, the imaging device in the second operation mode has a second timeout period for decoding the damaged indicia, and the second timeout period is longer than the first timeout period.

In yet another variation of the embodiment, decoding the damaged indicia in accordance with the second operation mode includes: analyzing each of at least one of (i) rows or (ii) columns of the damaged indicia.

In still yet another variation of the embodiment, the image data is first image data, and detecting the indication of the parameter change includes: receiving, from the imaging assembly, second image data of a parameter indicia in the FOV; decoding, at the decode module and after receiving the second image data, the parameter indicia; and detecting the indication of the parameter change responsive to decoding the parameter indicia.

In yet another variation of the embodiment, the image data is first image data, and detecting the indication of the parameter change includes: receiving, from the imaging assembly, second image data of a parameter indicia in the FOV; decoding, at the decode module and after receiving the second image data, the parameter indicia; and detecting the indication of the parameter change responsive to decoding the parameter indicia.

In another variation of the embodiment, detecting the indication of the parameter change includes: receiving, at the imaging device, the decode parameter from a user; and detecting the indication of the parameter change responsive to receiving the decode parameter.

In yet another variation, transitioning to the second operation mode is responsive to determining that a switch parameter indicates that the imaging device is enabled for damaged decode operations.

In yet another variation, the decode parameters are representative of scenarios in which the damage includes at least: (i) the indicia missing a portion of a timing pattern, (ii) the indicia missing an entirety of the timing pattern, (iii) the indicia missing a portion of a solid edge indicative of an indicia type, (iv) the indicia missing an entirety of the solid edge, (v) the indicia missing the portion of the solid edge and the portion of the timing pattern, (vi) the indicia missing the portion of the solid edge and the entirety of the timing pattern, (vii) the indicia missing the portion of the timing pattern and the entirety of the solid edge, or (viii) the indicia missing the entirety of the solid edge and the entirety of the timing pattern.

In still yet another variation, a first timeout period associated with at least some of the scenarios (i)-(vii) is different than a second timeout period associated with a remainder of the scenarios (i)-(vii).

In another variation, the indication of the parameter change is a decode event associated with decoding a parameter indicia.

In another embodiment, a method implemented in an imaging device including an imaging assembly configured to capture image data of an indicia appearing in a field of view (FOV) and a decode module configured to decode the indicia using the image data. The method includes: (i) detecting, by one or more processors of the imaging device, an indication of a parameter change for a decode parameter associated with the imaging device, wherein the decode parameter is indicative of damage associated with the indicia; (ii) transitioning, by the one or more processors and responsive to detecting the indication of the parameter change, from a first operation mode associated with decoding the indicia to a second operation mode associated with decoding the indicia, wherein the decode module is configured to decode the indicia based at least on the damage associated with the indicia while operating in the second operation mode; (iii) receiving, by the one or more processors, image data of a damaged indicia appearing in the FOV, wherein the damaged indicia is representative of the indicia and the damage associated with the indicia; and (iv) decoding, by the one or more processors, the damaged indicia in accordance with the second operation mode.

In a variation of the embodiment, the indicia is a two-dimensional (2D) barcode including a finder pattern and/or a timing pattern positioned along at least one edge of the 2D barcode.

In another variation of the embodiment, the method further comprises: after decoding the damaged indicia, transitioning, by the one or more processors, from the second operation mode to the first operation mode.

In yet another variation of the embodiment, the image data is first image data, and the method further comprises: receiving, by the one or more processors, second image data of an undamaged indicia; and decoding, by the one or more processors the undamaged indicia in accordance with the first operation mode.

In still another variation of the embodiment, decoding the damaged indicia occurs during a second timeout period longer than a first timeout period associated with a time period for decoding the indicia when in the first operation.

In still yet another variation of the embodiment, decoding the damaged indicia in accordance with the second operation mode includes: analyzing each of at least one of (i) rows or (ii) columns of the damaged indicia.

In another variation of the embodiment, decoding the damaged indicia in accordance with the second operation mode includes: determining a type of indicia for the damaged indicia; identifying corners of the indicia based on the type of indicia; and decoding the damaged indicia within the corners.

In yet another variation of the embodiment, the image data is first image data, and detecting the indication of the parameter change includes: receiving, from the imaging assembly, second image data of a parameter indicia in the FOV; decoding, at the decode module and after receiving the second image data, the parameter indicia; and detecting the indication of the parameter change responsive to decoding the parameter indicia.

In still another variation of the embodiment, detecting the indication of the parameter change includes: receiving, at the imaging device, the decode parameter from a user; and detecting the indication of the parameter change responsive to receiving the decode parameter.

In still yet another variation of the embodiment, transitioning to the second operation mode is responsive to determining that a switch parameter indicates that the imaging device is enabled for damaged decode operations.

In another variation of the embodiment, the decode parameters are representative of scenarios in which the damage includes at least: (i) the indicia missing a portion of a timing pattern, (ii) the indicia missing an entirety of the timing pattern, (iii) the indicia missing a portion of a solid edge indicative of an indicia type, (iv) the indicia missing an entirety of the solid edge, (v) the indicia missing the portion of the solid edge and the portion of the timing pattern, (vi) the indicia missing the portion of the solid edge and the entirety of the timing pattern, (vii) the indicia missing the portion of the timing pattern and the entirety of the solid edge, or (viii) the indicia missing the entirety of the solid edge and the entirety of the timing pattern.

In yet another variation of the embodiment, a first timeout period associated with at least some of the scenarios (i)-(vii) is different than a second timeout period associated with a remainder of the scenarios (i)-(vii).

In still another variation of the embodiment, the indication of the parameter change is a decode event associated with decoding a parameter indicia.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1A illustrates a front perspective view of a first example handheld barcode reader;

FIG. 1B illustrates a back perspective view of the handheld barcode reader of FIG. 1A;

FIG. 2 illustrates a block diagram of an example imaging device such as the example handheld barcode reader of FIG. 1A;

FIG. 3A illustrates an example indicia in which the example indicia is undamaged and is to be decoded by an example imaging device, such as the handheld barcode reader of FIG. 1A;

FIG. 3B illustrates example indicia to be decoded similar to that of FIG. 3A, but in which the example indicia are damaged such that each example indicia is damaged in at least part of a timing pattern;

FIG. 3C illustrates an example indicia to be decoded similar to that of FIG. 3B, but in which the example indicia is damaged such that the entire timing pattern is damaged;

FIG. 3D illustrates example indicia to be decoded similar to that of FIG. 3A, but in which the example indicia are damaged such that each example indicia is damaged in at least part of a finder pattern;

FIG. 3E illustrates example indicia to be decoded similar to that of FIG. 3D, but in which the example indicia is damaged such that the entire finder pattern is damaged;

FIG. 3F illustrates example indicia to be decoded similar to that of FIG. 3A, but in which the example indicia are damaged such that each example indicia is damaged in at least part of a timing pattern and a finder pattern;

FIG. 3G illustrates example indicia to be decoded similar to that of FIG. 3F, but in which the example indicia is damaged such that the entire timing pattern and finder pattern are damaged; and

FIG. 4 illustrates a flow diagram of an example method for transitioning to an operation mode to decode a damaged indicia, to be implemented in an imaging device such as the handheld barcode reader of FIG. 1A.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The example imaging devices disclosed herein utilize operation mode switching techniques to change operation modes depending on whether an indicia is damaged, marked, or otherwise blemished such that different decoding techniques are to be used. By operating in a first operation mode for normal decoding operations and changing to a second operation mode for decoding damaged indicia, the imaging device is able to improve the overall operation by reducing overall computation time (e.g., depending on the implementation, by a factor of 2 or 3) and computing resources, while enabling the imaging device to decode damaged indicia. Further, by utilizing techniques for decoding indicia by scanning the indicia row-by-row or column-by-column as necessary in conjunction with varying timeout periods, the imaging device is advantageously able to decode indicia with varying degrees of damage.

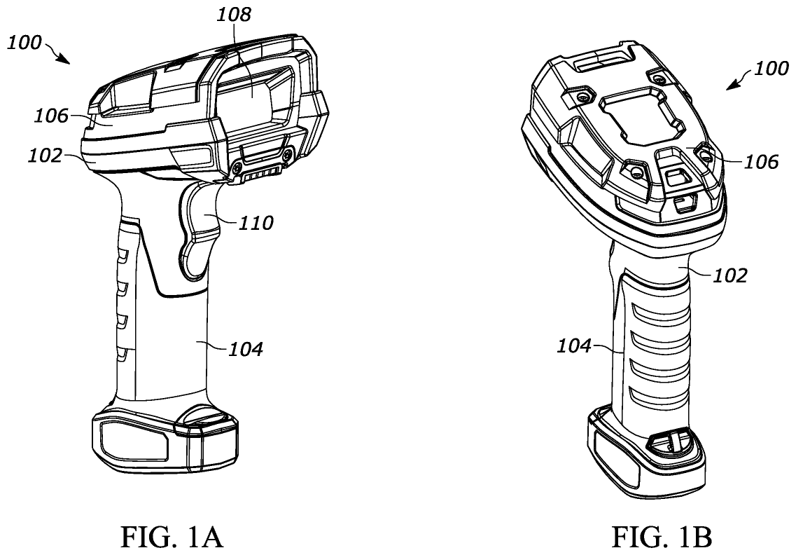

Referring to the figures, FIGS. 1A and 1B illustrate an exemplary handheld imaging device 100 having a housing 102 with a handle portion 104, also referred to as a handle 104, and a head portion 106, also referred to as a scanning head 106. The head portion 106 includes a window 108 and is configured to be positioned on the top of the handle portion 104. The handle portion 104 is configured to be gripped by a reader user and includes a trigger 110 for activation by the user. Optionally included in an embodiment is also a base (not shown), also referred to as a base portion, that may be attached to the handle portion 104 opposite the head portion 106 and is configured to stand on a surface and support the housing 102 in a generally upright position. The handheld imaging device 100 can be used in a hands-free mode as a stationary workstation when it is placed on a countertop or other workstation surface. The handheld imaging device 100 can also be used in a handheld mode when it is picked up off the countertop or base station and held in an operator's hand. In the hands-free mode, products can be slid, swiped past, or presented to the window 108 for the reader to initiate barcode reading operations. In the handheld mode, the barcode reader 100 can be moved towards a barcode on a product, and the trigger 110 can be manually depressed to initiate imaging of the barcode.

Other implementations may provide only handheld or only hands-free configurations. In the embodiment of FIGS. 1A and 1B, the handheld imaging device 100 is ergonomically configured for a user's hand, though other configurations may be utilized as understood by those of ordinary skill in the art. As shown, the lower handle 104 extends below and rearwardly away from the body 102 along a centroidal axis obliquely angled relative to a central FOV axis of a FOV of an imaging assembly within the scanning head 102.

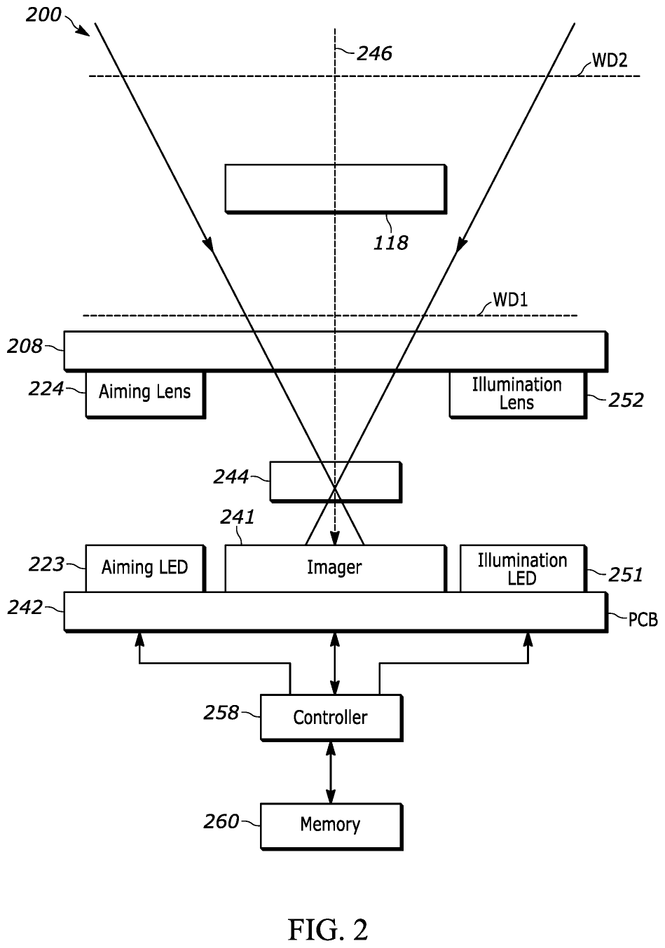

In some embodiments, an imaging assembly includes a light-detecting sensor or imager operatively coupled to, or mounted on, a printed circuit board (PCB) in the handheld imaging device 100 as shown in FIG. 2. In further embodiments, an illuminating light assembly is also mounted in the handheld imaging device 100. The illuminating light assembly may include an illumination light source and at least one illumination lens, configured to generate a substantially uniform distributed illumination pattern of illumination light on and along an object to be read by image capture, as described below with regard to FIG. 2.

Referring next to FIG. 2, a block diagram of an example architecture for an imaging device such as handheld imaging device 100 is shown. For at least some of the reader implementations, an imaging assembly 245 includes a light-detecting sensor or imager 241 operatively coupled to, or mounted on, a printed circuit board (PCB) 242 in the imaging device 200 as shown in FIG. 2. In an implementation, the imager 241 is a solid-state device, for example, a CCD or a CMOS imager, having a one-dimensional array of addressable image sensors or pixels arranged in a single row, or a two-dimensional array of addressable image sensors or pixels arranged in mutually orthogonal rows and columns, and operative for detecting return light captured by an imaging assembly 245 over a field of view along an imaging axis 246 through the window 208. The imager 241 may also include and/or function as a monochrome sensor and, in further implementations, a color sensor. It should be understood that the terms “imager”, “image sensor”, and “imaging sensor” are used interchangeably herein. Depending on the implementation, imager 241 may include a color sensor such as a vision camera in addition to and/or as an alternative to the monochrome sensor. In some implementations, the imager 241 is or includes a barcode reading module (e.g., a monochromatic imaging sensor). In further implementations, the imager 241 additionally or alternatively is or includes a vision camera (e.g., a color imaging sensor). It will be understood that, although imager 241 is depicted in FIG. 2 as a single block, that imager 241 may be multiple sensors spread out in different locations of imaging device 200.

The return light is scattered and/or reflected from an object 118 over the field of view. The imaging lens 244 is operative for focusing the return light onto the array of image sensors to enable the object 118 to be imaged. In particular, the light that impinges on the pixels is sensed and the output of those pixels produce image data that is associated with the environment that appears within the FOV (which can include the object 118). This image data is typically processed by a controller (usually by being sent to a decoder) which identifies and decodes decodable indicia captured in the image data. Once the decode is performed successfully, the reader can signal a successful “read” of the object 118 (e.g., a barcode). The object 118 may be located anywhere in a working range of distances between a close-in working distance (WD1) and a far-out working distance (WD2). In an implementation, WD1 is about one-half inch from the window 208, and WD2 is about thirty inches from the window 208.

An illuminating light assembly may also be mounted in, attached to, or associated with the imaging device 200. The illuminating light assembly includes an illumination light source 251, such as at least one light emitting diode (LED) and at least one illumination lens 252, and preferably a plurality of illumination and illumination lenses, configured to generate a substantially uniform distributed illumination pattern of illumination light on and along the object 118 to be imaged by image capture. Although FIG. 2 illustrates a single illumination light source 251, it will be understood that the illumination light source 251 may include more light sources. At least part of the scattered and/or reflected return light is derived from the illumination pattern of light on and along the object 118.

An aiming light assembly may also be mounted in, attached to, or associated with the imaging device 200 and preferably includes an aiming light source 223 (e.g., one or more aiming LEDs or laser light sources) and an aiming lens 224 for generating and directing a visible aiming light beam away from the imaging device 200 onto the object 118 in the direction of the FOV of the imager 241. It will be understood that, although the aiming light assembly and the illumination light assembly both provide light, an aiming light assembly differs from the illumination light assembly at least in the type of light the component provides. For example, the illumination light assembly provides diffuse light to sufficiently illuminate an object 118 and/or an indicia of the object 118 (e.g., for image capture). An aiming light assembly instead provides a defined illumination pattern (e.g., to assist a user in visualizing some portion of the FOV). Similarly, in some implementations, the illumination light source 251 and the aiming light source 223 are active at different, non-overlapping times. For example, the illumination light source 251 may be active on frames when image data is being captured and the aiming light source 223 may be active on frames when image data is not being captured (e.g., to avoid interference with the content of the image data).

In further implementations, the imaging device 200 may additionally emit an auditory cue when decoding an indicia or otherwise reading an object 118, such as a chime, beep, message, etc. In still further implementations, the imaging device 200 may additionally or alternatively provide haptic feedback to a user, such as vibration (e.g., a single vibration, vibrating in a predetermined pattern, vibrating synchronized with the flashing, etc.).

Further, the imager 241, the illumination source 251, and the aiming source 223 are operatively connected to a controller or programmed controller 258 (e.g., a microprocessor facilitating operations of the other components of imaging device 200) operative for controlling the operation of these components. In some implementations, the controller 258 functions as or is communicatively coupled to a vision application processor for receiving, processing, and/or analyzing the image data captured by the imager 241.

A memory 260 is connected and accessible to the controller 258. Preferably, the controller 258 is the same as the one used for processing the captured return light from the illuminated object 118 to obtain data related to the object 118. Though not shown, additional optical elements, such as collimators, lenses, apertures, compartment walls, etc. may be provided in the housing. Although FIG. 2 shows the imager 241, the illumination source 251, and the aiming source 223 as being mounted on the same PCB 242, it should be understood that different implementations of the imaging device 200 may have these components each on a separate PCB, or in different combinations on separate PCBs. For example, in an implementation of the imaging device 200, the illumination LED source is provided as an off-axis illumination (i.e., has a central illumination axis that is not co-axial with the central FOV axis).

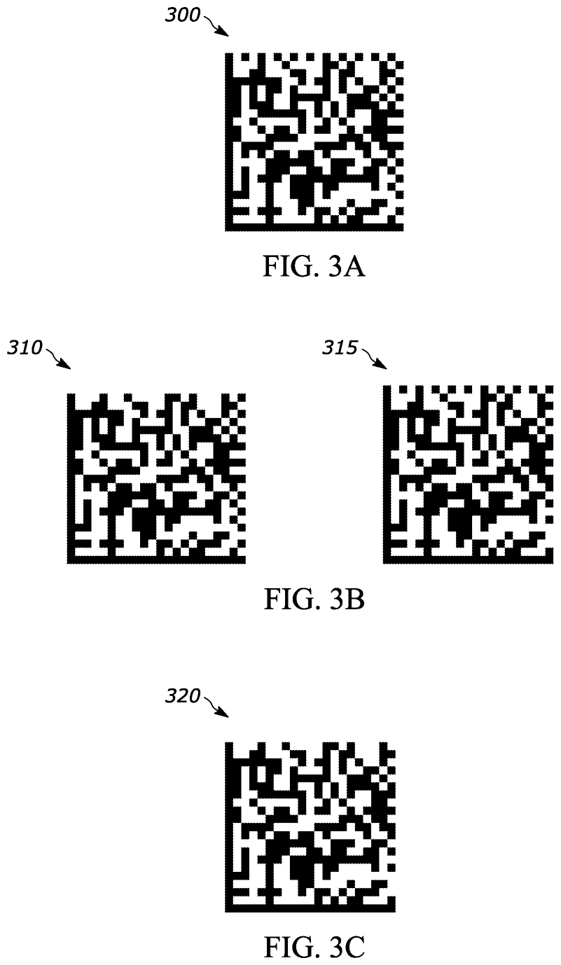

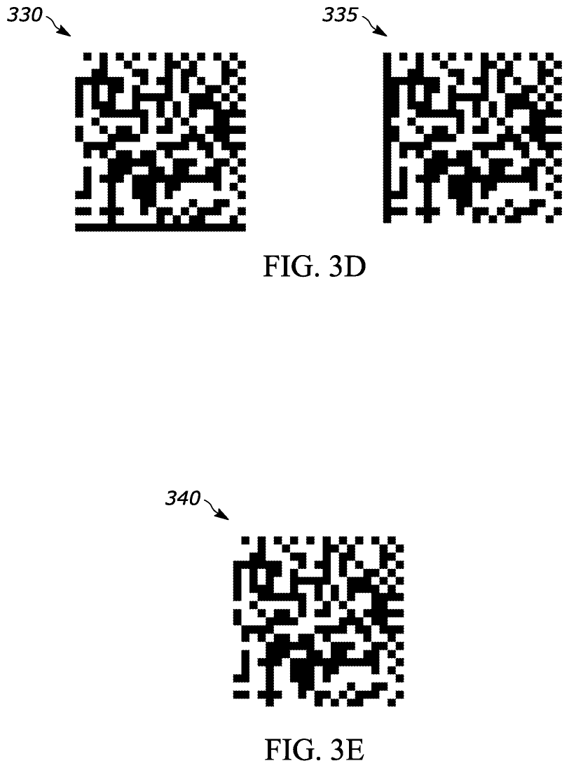

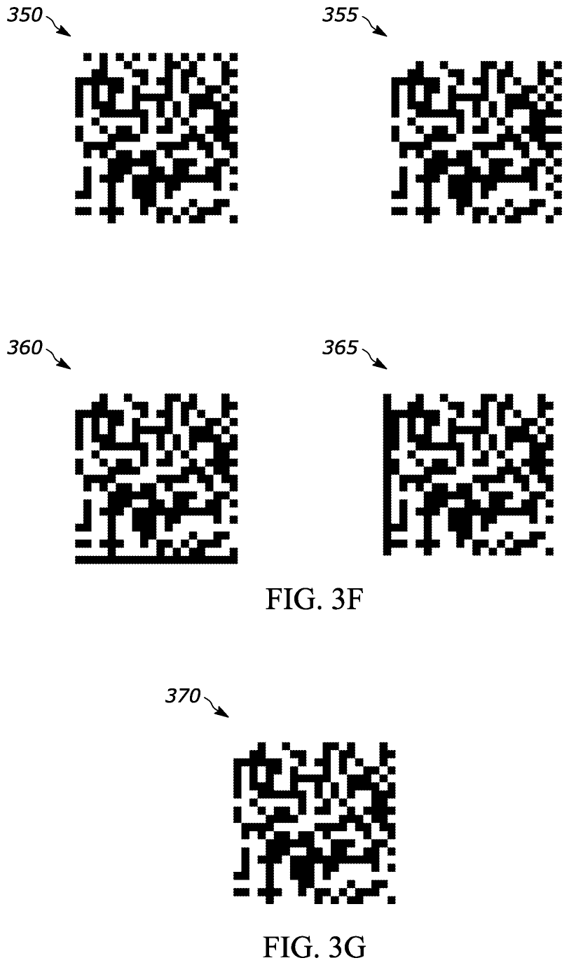

Referring next to FIGS. 3A-3G, FIG. 3A illustrates an example indicia 300 representative of an undamaged indicia. FIGS. 3B-3G each depicts one or more example damaged indicia 310-370 for an imaging device (e.g., handheld imaging device 100, imaging device 200, etc.) to decode according to the techniques described herein.

FIG. 3A depicts an undamaged indicia 300. In the exemplary embodiment of FIG. 3A, the undamaged indicia 300 is a 2D barcode (e.g., a Data Matrix barcode). As such, in some implementations, the undamaged indicia 300 includes a finder pattern (e.g., the two solid lines on the undamaged indicia 300) and a zipper or timing pattern (e.g., the alternating black and white modules along two sides of the border). Depending on the implementation, the finder pattern is an L-shaped pattern that an imaging device uses for locating a position and orientation of the undamaged indicia 300 within a scanned image. The finder pattern assists the imaging device in correctly decoding the undamaged indicia 300, even when tilted, rotated, mirrored, inverted, etc. In further implementations, the timing pattern divides the undamaged indicia 300 into individual cells, which assists the imaging device in accurately interpretating data contained in the undamaged indicia 300. The timing pattern further provides a clocking signal for the barcode reader to start and stop reading each cell. Put another way, the timing pattern assists and/or enables an imaging device in approximating a number of rows or columns in the indicia. Damage to the finder pattern and/or timing pattern, then can cause errors or no decode when a conventional system attempts to decode the indicia. Each of FIGS. 3B-3G depicts potential scenarios for damage to some such indicia.

FIG. 3B depicts damaged indicia 310 and 315, each with damage to part of the timing pattern (e.g., with a row or column of the timing pattern missing for damaged indicia 310 and damaged indicia 315, respectively). Similarly, FIG. 3C depicts a damaged indicia 320 with damage to an entirety of the timing pattern. In conventional systems, damage to part or all of the timing pattern can cause problems when the imaging device attempts to detect the individual cells and decode information associated with such.

Similarly, FIGS. 3D and 3E depict damaged indicia 330, 335, and 340. Depending on the implementation, damaged indicia 330 has damage to a column of the finder pattern, damaged indicia 335 has damage to a row of the finder pattern, and damaged indicia 340 has damage to the entirety of the finder pattern. In conventional systems, damage to part or all of the finder pattern can cause problems when the imaging device attempts to locate the position and/or orientation of the indicia, leading to errors in the decoding process or no decode.

FIGS. 3F and 3G depict damaged indicia 350, 355, 360, 365, and 370, each with damage to at least part of both the finder pattern and the timing pattern. Depending on the implementation, damaged indicia 350 has damage to the entirety of the finder pattern and a column of the timing pattern. Similarly, damaged indicia 355 has damage to the entirety of the finder pattern and a row of the timing pattern. In contrast, damaged indicia 360 has damage to the entire timing pattern and a column of the finder pattern, while damaged indicia 365 has damage to the entire timing pattern and a row of the finder pattern. The damaged indicia 370 has damage to the entirety of the timing pattern and the finder pattern.

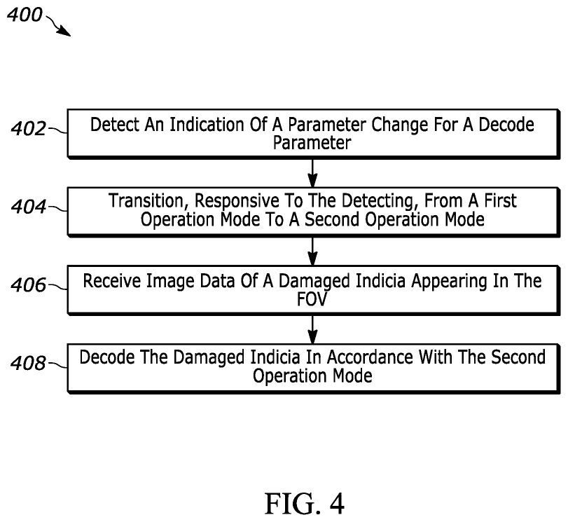

Referring next to FIG. 4, the method 400 illustrates a flow diagram of an example method for transitioning to and operating in a mode for decoding damaged indicia (e.g., as described in FIGS. 3A-3G above). Although the method 400 is described below with regard to imaging device 200 and components thereof as illustrated in FIG. 2, it will be understood that other similarly suitable imaging devices and/or components may be used instead.

At block 402, the imaging device 200 detects an indication of a parameter change for a decode parameter. In some implementations, the imaging device 200 detects the indication via an imaging assembly configured to capture image data appearing in a field of view (FOV). In some implementations, the decode parameter is indicative of damage associated with the indicia. In some implementations, the decode parameter is or includes a pair of decode parameters. In some such implementations, one of the decode parameters is a hard parameter, in that if the parameter indicates enabled, then the imaging device 200 has the second operation mode (e.g., as described below) enabled and, if the parameter indicates disabled, then the imaging device 200 does not have the second operation mode enabled. In further implementations, a second decode parameter of the pair of decode parameters is representative of any of a damage type, as described herein.

In further implementations, detecting the indication of the parameter change includes receiving second image data of a parameter indicia in the FOV, decoding the parameter indicia, and detecting the indication of the parameter change responsive to decoding the parameter indicia. Depending on the implementation, the parameter indicia may be indicative of a particular type of damage. For example, the decode parameters and/or parameter indicia may be representative of scenarios in which the damage includes at least: (i) the indicia missing a portion of a timing pattern, (ii) the indicia missing an entirety of the timing pattern, (iii) the indicia missing a portion of a solid edge indicative of an indicia type, (iv) the indicia missing an entirety of the solid edge, (v) the indicia missing the portion of the solid edge and the portion of the timing pattern, (vi) the indicia missing the portion of the solid edge and the entirety of the timing pattern, (vii) the indicia missing the portion of the timing pattern and the entirety of the solid edge, (viii) the indicia missing the entirety of the solid edge and the entirety of the timing pattern, and/or (ix) any other such damage to the indicia as described herein. In some such implementations, the indication of the parameter change is a decode event associated with decoding a parameter indicia (e.g., a barcode, QR code, etc. configured to modify parameters upon being scanned and decoded).

In still further implementations, detecting the indication of the parameter change may include receiving the decode parameter from a user and detecting the indication of the parameter change responsive to receiving the decode parameter. For example, the user may indicate and/or input a decode parameter (e.g., via the imaging device 200 and/or an interface of a computing device communicatively coupled to the imaging device 200) to the imaging device 200 to indicate damage to the indicia. In some implementations, the user indicates, configures, and/or otherwise inputs the decode parameter to the imaging device 200 via configuration software installed on a computing device communicatively coupled to the imaging device.

At block 404, the imaging device 200 transitions, responsive to the detecting at block 402, from a first operation mode to a second operation mode. In some implementations, the decode module is configured to decode the indicia based at least on the damage associated with the indicia while operating in the second operation mode. In further implementations, a decode module of the imaging device 200 is configured to decode the indicia without damage while operating in the first operation mode. In further such implementations, the decode module is configured to decode the indicia with damage while operating in the second operation mode. In particular, the second operation mode may include one or more parameters and/or functionalities based on the damage to the indicia and/or indicated decode parameters as described above with regard to block 402.

In further implementations, the imaging device 200 has a timeout period associated with decoding the indicia. Depending on the implementation, the timeout period may be different depending on the operation mode. For example, the imaging device may have a first timeout period for decoding the indicia when operating in the first operation mode and may have a second timeout period for decoding the damaged indicia in the second operation mode. Moreover, in some implementations, the second timeout period is longer than the first timeout period to allow the imaging device 200 a greater period of time in which to decode the damaged indicia. In further implementations, the timeout period is different based on the damage scenario. For example, at least some of the scenarios (i)-(viii) listed with regard to block 402 have a different timeout period than others of the scenarios (i)-(viii). For example, some scenarios may have a timeout period of 100 ms while more complex scenarios (e.g., scenario viii) may have a higher timeout period (e.g., 250 ms, 500 ms, 1 s, etc.).

At block 406, the imaging device 200 receives image data associated with a damaged indicia appearing in the FOV (e.g., the indicia). In some implementations, the indicia is a 1D barcode (e.g., a linear barcode) or a 2D barcode (e.g., a Data Matrix barcode, a QR code, etc.). In further such implementations, the indicia includes a finder pattern positioned along at least one edge of the 2D barcode and/or a timing pattern positioned along at least one edge of the 2D barcode, as described herein.

At block 408, the imaging device 200 decodes the damaged indicia in accordance with the second operation mode. In some implementations, decoding the damaged indicia includes analyzing each of at least one of (i) rows or (ii) columns of the damaged indicia. In further such implementations, the imaging device 200 analyzes the rows, the columns, or both depending on the damage to the indicia (e.g., whether damage is to a row or column of the finder pattern and/or timing pattern). Depending on the implementation, the imaging device 200 decodes the damaged indicia differently depending on the indication received at block 402. For example, the indication may be a parameter from 1-8 (with 1 being undamaged and 8 being damaged in accordance with FIG. 3G). The imaging device 200 may analyze each row for some parameter values, each column for other parameter values, and both for still other parameter values. In further implementations, the imaging device 200 may perform each analysis type when the parameter values is set to a maximum.

In some implementations, the imaging device 200 analyzes the indicia by starting at a point and attempting to find each corner of the indicia. The imaging device 200 then tries different types of indicia scanning (e.g., to determine whether the indicia is a Data Matrix, QR code, linear barcode, etc.). For some such implementations, the imaging device 200 determines the shape, corner, indicia type, etc. based on a stored database of codes (e.g., if there are no 19×19 module Data Matrix barcodes, then the imaging device 200 determines that the Data Matrix is a damaged 20×20 module Data Matrix).

In further implementations, decoding the damaged indicia includes determining a type of indicia for the damaged indicia, identifying corners of the indicia based on the type of indicia, and decoding the damaged indicia within the corners. For example, if the type of indicia is a Data Matrix barcode, the imaging device 200 may identify corners of the indicia as where the finder pattern and/or timing pattern are and/or should be. As a further example, if the type of indicia is a QR code, the imaging device 200 may identify corners based on the finder patterns located in corners of the barcode.

In some implementations, the imaging device 200 decodes the damaged indicia at the imaging device 200 (e.g., via a decoding module on an ASIC of the imaging device 200). In further implementations, the imaging device 200 decodes the damaged indicia by starting the analysis and/or decoding process at the imaging device 200 before transmitting the data to a communicatively coupled device to finish the decoding process. In still further implementations, the imaging device 200 performs the decoding operation by transmitting data to a communicatively coupled device immediately along with an indication to (and/or an indication of how to) decode the indicia.

In still further implementations, the imaging device 200 additionally transitions from the second operation mode to the first operation mode after decoding the damaged indicia. In some such implementations, the decode module is configured to decode the indicia without the damage associated with the indicia while operating in the first operation mode. In other such implementations, the first operation mode is an inactive mode in which the imaging device 100 does not decode indicia. In further implementations, the imaging device 200 transitions from the second operation mode to a third operation mode after decoding the damaged indicia. In some such implementations, the decode module is configured to decode the indicia without the damage associated with the indicia while operating in the third operation mode. In other such implementations, the third operation mode is an inactive mode in which the imaging device 100 does not decode indicia. In still further implementations, the imaging device 200 turns off after decoding the damaged indicia. In yet still further implementations, the imaging device 200 remains in the second operation mode until scanning and/or receiving an indication to change operation modes.

Embodiments of the present disclosure may have certain advantages over traditional approaches. For example, using multiple operation modes can reduce overall computation time and resource usage by an imaging device. Similarly, varying the techniques performed according to the damage further enables an imaging device to decode a wider range of damaged indicia while further refining the improvement to computation time and resource usage described herein.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. An imaging device, comprising:
an imaging assembly configured to capture image data of an indicia appearing in a field of view (FOV);
a decode module configured to decode the indicia using the image data; and
a computer-readable media storing machine readable instructions that, when executed, cause the imaging device to:
detect an indication of a parameter change for a decode parameter associated with the imaging device, wherein the decode parameter is indicative of damage associated with the indicia;
transition, responsive to detecting the indication of the parameter change, from a first operation mode associated with decoding the indicia to a second operation mode associated with decoding the indicia, wherein the decode module is configured to decode the indicia based at least on the damage associated with the indicia while operating in the second operation mode;
receive, from the imaging assembly, image data associated with the indicia; and
decode, at the decode module, the indicia in accordance with the second operation mode.

2. The imaging device of claim 1, wherein the indicia is a two-dimensional (2D) barcode including at least one of a finder pattern or a timing pattern positioned along at least one edge of the 2D barcode.

3. The imaging device of claim 1, wherein the computer-readable media further stores additional instructions that, when executed, cause the imaging system to:
after decoding the indicia, transition from the second operation mode to the first operation mode.

4. The imaging device of claim 3, wherein the decode module is configured to decode the indicia without the damage associated with the indicia while operating in the first operation mode.

5. The imaging device of claim 1, wherein the imaging device in the first operation mode has a first timeout period for decoding the indicia, the imaging device in the second operation mode has a second timeout period for decoding the indicia, and the second timeout period is longer than the first timeout period.

6. The imaging device of claim 1, wherein decoding the indicia in accordance with the second operation mode includes:
analyzing each of at least one of (i) rows or (ii) columns of the indicia.

7. The imaging device of claim 1, wherein decoding the indicia in accordance with the second operation mode includes:
determining a type of indicia for the indicia;
identifying corners of the indicia based on the type of indicia; and
decoding the indicia within the corners.

8. The imaging device of claim 1, wherein the image data is first image data, and detecting the indication of the parameter change includes:
receiving, from the imaging assembly, second image data of a parameter indicia in the FOV;
decoding, at the decode module and after receiving the second image data, the parameter indicia; and
detecting the indication of the parameter change responsive to decoding the parameter indicia.

9. The imaging device of claim 1, wherein detecting the indication of the parameter change includes:
receiving, at the imaging device, the decode parameter from a user; and
detecting the indication of the parameter change responsive to receiving the decode parameter.

10. The imaging device of claim 1, wherein transitioning to the second operation mode is responsive to determining that a switch parameter indicates that the imaging device is enabled for damaged decode operations.

11. The imaging device of claim 1, wherein the decode parameters are representative of scenarios in which the damage includes at least: (i) the indicia missing a portion of a timing pattern, (ii) the indicia missing an entirety of the timing pattern, (iii) the indicia missing a portion of a solid edge indicative of an indicia type, (iv) the indicia missing an entirety of the solid edge, (v) the indicia missing the portion of the solid edge and the portion of the timing pattern, (vi) the indicia missing the portion of the solid edge and the entirety of the timing pattern, (vii) the indicia missing the portion of the timing pattern and the entirety of the solid edge, or (viii) the indicia missing the entirety of the solid edge and the entirety of the timing pattern.

12. The imaging device of claim 11, wherein a first timeout period associated with at least some of the scenarios (i)-(vii) is different than a second timeout period associated with a remainder of the scenarios (i)-(vii).

13. The imaging device of claim 1, wherein the indication of the parameter change is a decode event associated with decoding a parameter indicia.

14. A method implemented in an imaging device including an imaging assembly configured to capture image data of an indicia appearing in a field of view (FOV) and a decode module configured to decode the indicia using the image data, the method comprising:
detecting, by one or more processors of the imaging device, an indication of a parameter change for a decode parameter associated with the imaging device, wherein the decode parameter is indicative of damage associated with the indicia;
transitioning, by the one or more processors and responsive to detecting the indication of the parameter change, from a first operation mode associated with decoding the indicia to a second operation mode associated with decoding the indicia, wherein the decode module is configured to decode the indicia based at least on the damage associated with the indicia while operating in the second operation mode;
receiving, by the one or more processors, image data associated with the indicia; and
decoding, by the one or more processors, the indicia in accordance with the second operation mode.

15. The method of claim 14, wherein the indicia is a two-dimensional (2D) barcode including at least one of a finder pattern or a timing pattern positioned along at least one edge of the 2D barcode.

16. The method of claim 14, wherein the method further comprises:
after decoding the indicia, transitioning, by the one or more processors, from the second operation mode to the first operation mode.

17. The method of claim 16, wherein the image data is first image data, and the method further comprises:
receiving, by the one or more processors, second image data of an undamaged indicia;
decoding, by the one or more processors the undamaged indicia in accordance with the first operation mode.

18. The method of claim 14, wherein decoding the indicia occurs during a second timeout period longer than a first timeout period associated with a time period for decoding the indicia when in the first operation.

19. The method of claim 14, wherein decoding the indicia in accordance with the second operation mode includes:
analyzing each of at least one of (i) rows or (ii) columns of the indicia.

20. The method of claim 14, wherein decoding the indicia in accordance with the second operation mode includes:
determining a type of indicia for the indicia;
identifying corners of the indicia based on the type of indicia; and
decoding the indicia within the corners.

21. The method of claim 14, wherein the image data is first image data, and detecting the indication of the parameter change includes:
receiving, from the imaging assembly, second image data of a parameter indicia in the FOV;
decoding, at the decode module and after receiving the second image data, the parameter indicia; and
detecting the indication of the parameter change responsive to decoding the parameter indicia.

22. The method of claim 14, wherein detecting the indication of the parameter change includes:
receiving, at the imaging device, the decode parameter from a user; and
detecting the indication of the parameter change responsive to receiving the decode parameter.

23. The method of claim 14, wherein transitioning to the second operation mode is responsive to determining that a switch parameter indicates that the imaging device is enabled for damaged decode operations.

24. The method of claim 14, wherein the decode parameters are representative of scenarios in which the damage includes at least: (i) the indicia missing a portion of a timing pattern, (ii) the indicia missing an entirety of the timing pattern, (iii) the indicia missing a portion of a solid edge indicative of an indicia type, (iv) the indicia missing an entirety of the solid edge, (v) the indicia missing the portion of the solid edge and the portion of the timing pattern, (vi) the indicia missing the portion of the solid edge and the entirety of the timing pattern, (vii) the indicia missing the portion of the timing pattern and the entirety of the solid edge, or (viii) the indicia missing the entirety of the solid edge and the entirety of the timing pattern.

25. The imaging device of claim 24, wherein a first timeout period associated with at least some of the scenarios (i)-(vii) is different than a second timeout period associated with a remainder of the scenarios (i)-(vii).

26. The imaging device of claim 14, wherein the indication of the parameter change is a decode event associated with decoding a parameter indicia.
